(19) United States
(12) Patent Application Publication
(10) Pub. No.: US 2025/0307180 A1
(43) Pub. Date: Oct. 2, 2025

(54) Software Runtime Assisted Co-Processing Acceleration with a Memory Hierarchy Augmented with Compute Elements

(71) Applicant: Advanced Micro Devices, Inc., Santa Clara, CA (US)

(72) Inventors: Pratik Mishra, San Jose, CA (US); Marko Scrbak, Dripping Springs, TX (US)

(73) Assignee: Advanced Micro Devices, Inc., Santa Clara, CA (US)

(21) Appl. No.: 18/618,442

(22) Filed: Mar. 27, 2024

(51) Int. Cl. G06F 13/16; G06F 8/41

(52) U.S. Cl. CPC G06F 13/1642; G06F 8/41; G06F 13/1657

(57) ABSTRACT

The concepts and technologies disclosed herein are directed to software runtime assisted co-processing acceleration with a memory hierarchy augmented with compute elements. An example system disclosed herein includes one or more switches and a plurality of hardware compute nodes connected via the one or more switches. Each hardware compute node of the plurality of hardware compute nodes includes an in-memory compute (IMC) element configured to perform in-memory processing operations on data, such as graph data. The system also includes a near-memory compute (NMC) element configured to perform near-memory processing operations on the data. The system also includes a far-memory compute (FMC) element configured to perform far-memory processing operations on the data.

### GOVERNMENT LICENSE RIGHTS

This invention was made with government support under Government Contract Number W911NF-22-C-0085 awarded by Intelligence Advanced Research Projects Activity (IARPA) as part of Advanced Graphic Intelligence Logical Computing Environment (AGILE) program. The government has certain rights in the invention.

### BACKGROUND

Graph analytics is the process of analyzing and interpreting data structured in a graph format, where entities represented as nodes are connected by relationships represented as edges. Graph analytics focuses on studying the relationships, structures, patterns, and properties of data rather than individual data values. This approach provides unique insights into complex systems and is widely used in various domains like social networks, biological systems, transportation, and more.

### BRIEF DESCRIPTION OF THE DRAWINGS

FIG. 1 is a block diagram of a non-limiting example compute everywhere processing hierarch or CEPH system having one or more in-memory compute or IMC elements, one or more near-memory compute or NMC elements, and one or more far-memory compute or FMC elements.

FIG. 2 is a block diagram of a non-limiting example memory subsystem architecture for a memory subsystem of the CEPH system depicted in FIG. 1.

FIG. 3 is a block diagram of a non-limiting example memory controller architecture for a memory controller of the memory subsystem depicted in FIG. 2.

FIG. 4 is a flow diagram of a non-limiting example method for implementing a CEPH optimized software directed data flow in hardware.

### DETAILED DESCRIPTION

### Overview

Ensuring high performance is of paramount importance for large scale graph processing systems. Graph workflows are generically characterized with sparseness having complex compute parallelism and memory access patterns. In a partitioned global address space (PGAS) system, for example, graph objects requested from memory are processed by a local compute element (i.e., co-located with the memory in the same server) or sent across a network to be processed by a remote compute element located in a different server.

For many graph workloads, a large amount of data is moved over the network from memory and/or storage subsystems to corresponding compute nodes. Moreover, many algorithms have low operational intensity coupled with substantial amounts of redundant and unnecessary data transferred from memory to compute, making it difficult for graphic analytics systems to infer small matching patterns. These issues become increasingly pronounced as the amount of data increases, resulting in performance degradation, read/write amplification, more network traffic, compute resource under-utilization, bandwidth wastage, stalls, and increased energy consumption.

Generally, to perform computations on data stored in memory, a system moves the data from the memory to compute registers through a cache hierarchy. The data most often used is stored in caches closest to a compute core. This procedure is suitable for many applications in which the data fetched from the memory is processed in full or otherwise with little waste. Graph workloads, however, include large amounts of data, but the amount of data required for processing is relatively much smaller. As a result, graph analytics systems oftentimes move the large amounts of data without performing any processing operations on the majority of that data. This renders caching effectively useless and incurs a huge performance penalty, particularly with regard to resource utilization and energy consumption.

The concepts and technologies disclosed herein are directed to a system designed to reduce data movement by implementing multiple compute elements within a memory hierarchy. Each compute element is or includes computational hardware, such as one or more processing units or processing cores, designed to execute instructions, perform operations, and/or process data at different levels within the memory hierarchy as the data moves towards a primary compute element, such as a host processor with one or more cores. The memory hierarchy includes one or more in-memory compute or IMC elements located within a memory system. In one or more implementations, the in-memory compute elements are or include one or more processing-in-memory components are mounted together with one or more memory chips as part of a memory system (e.g., on a circuit board containing one or more memory chips). The memory hierarchy also includes one or more near-memory compute or NMC elements located near the memory system. In one or more implementations, the near-memory compute elements are or include one or more processing units of (e.g., a memory management unit) a memory controller that is positioned between the memory system and the host processor. The far-memory compute or FMC elements are or include the host processor or host processor core(s) itself (e.g., a host processor). Each of these compute elements is configured to minimize data movement overhead by processing data where it resides rather than continually transferring the data back and forth between the processor and the memory. In some instances, the data is partially processed by one compute element before being transferred to another compute element in the memory hierarchy. In some instances, unneeded data is filtered out by one or more of the compute elements so that only the data that is needed for further processing is transferred to the next compute element in the hierarchy. This further reduces data movement within the system.

The system is also designed to use software runtime directed refactoring and characterization to identify code block or instructions that match the varying computing capabilities of the compute elements in the memory hierarchy. The identified code blocks or instructions are offloaded to the corresponding compute element (e.g., far-memory compute or FMC, near-memory compute or NMC, or in-memory compute or IMC) by specifying regions in the source code via compiler directives (e.g., “Pragma” compiler directives). For instance, the memory intensive portions of a given workflow are identified by observing redundant loops, comparisons (=, <, >), set operations, and the like. The data is reduced at the source using simple calculations and minimal overheads. During compilation, the compiler directives provide hints to one or more compilers for mapping instructions to hardware modules for processing by the specified compute element(s). The runtime schedules and orchestrates instructions and dataflows to specific compute elements for processing.

In some aspects, the techniques described herein relate to a system including: one or more switches, and a plurality of hardware compute nodes connected via the one or more switches, each hardware compute node of the plurality of hardware compute nodes including: an in-memory compute element configured to perform in-memory processing operations on data, a near-memory compute element configured to perform near-memory processing operations on the data, and a far-memory compute element configured to perform far-memory processing operations on the data.

In some aspects, the techniques described herein relate to a system, further including a circuit board having memory mounted to the circuit board, the circuit board including: the in-memory compute element, and one or more dynamic random-access memory banks.

In some aspects, the techniques described herein relate to a system, wherein the in-memory compute element includes a processing-in-memory component.

In some aspects, the techniques described herein relate to a system, further including a memory controller, the memory controller including the near-memory compute element.

In some aspects, the techniques described herein relate to a system, wherein the near-memory compute element includes a near-memory processor, and the memory controller further includes a traffic manager configured to direct traffic towards the near-memory processor, the processing-in-memory component, or the one or more dynamic random-access memory banks.

In some aspects, the techniques described herein relate to a system, wherein the traffic manager includes: a data queue configured to queue the data, a demand request queue configured to queue demand requests from the traffic, a compute everywhere processing hierarchy (CEPH) request queue configured to queue CEPH requests from the traffic, and a request arbitration logic configured to: direct native commands associated with the demand requests towards the memory, direct processing-in-memory commands associated the CEPH requests towards the processing-in-memory component to perform the in-memory processing operations on the data, and direct near-memory processing commands associated with the CEPH requests towards the near-memory processor to perform the near-memory processing operations on the data.

In some aspects, the techniques described herein relate to a system, wherein the traffic manager further includes: a demand response queue configured to queue demand responses, a CEPH response queue configured to queue CEPH responses, and a response arbitration logic configured to direct the demand responses and the CEPH responses towards the far-memory compute element to perform the far-memory processing operations on the data.

In some aspects, the techniques described herein relate to a system, wherein the far-memory compute element includes a command processor including one or more processing cores.

In some aspects, the techniques described herein relate to a system, wherein the command processor includes a local command processor of a local hardware compute node of the plurality of hardware compute nodes or a remote command processor of a remote hardware compute node of the plurality of hardware compute nodes.

In some aspects, the techniques described herein relate to a system, wherein the data includes graph data.

In some aspects, the techniques described herein relate to a hardware compute node including: an in-memory compute element configured to perform in-memory processing operations on data, a near-memory compute element configured to perform near-memory processing operations on the data, and a far-memory compute element configured to perform far-memory processing operations on the data.

In some aspects, the techniques described herein relate to a hardware compute node, further including a memory system, the memory system includes the in-memory compute element, and one or more dynamic random-access memory banks.

In some aspects, the techniques described herein relate to a hardware compute node, wherein the in-memory compute element includes a processing-in-memory component.

In some aspects, the techniques described herein relate to a hardware compute node, wherein the near-memory compute element includes a near-memory processor, and the hardware compute node further includes: a traffic manager of a memory controller, the traffic manager including: a data queue configured to queue the data, a demand request queue configured to queue demand requests, and a compute everywhere processing hierarchy (CEPH) request queue configured to queue CEPH requests, and a request arbitration logic of the memory controller, the request arbitration logic configured to: direct native commands associated with the demand requests towards the memory system, direct processing-in-memory commands associated with the CEPH requests towards the processing-in-memory component to perform the in-memory processing operations on the data, and direct near-memory processing commands associated with the CEPH requests towards the near-memory processor to perform the near-memory processing operations on the data.

In some aspects, the techniques described herein relate to a hardware compute node, wherein the traffic manager further includes: a demand response queue configured to queue demand responses, a CEPH response queue configured to queue CEPH responses, and a response arbitration logic configured to direct the demand responses and the CEPH responses towards the far-memory compute element to perform the far-memory processing operations on the data.

In some aspects, the techniques described herein relate to a hardware compute node, wherein the far-memory compute element includes a command processor including one or more cores.

In some aspects, the techniques described herein relate to a method including: analyzing source code to identify one or more code regions to be offloaded to a compute element, specifying the one or more code regions within the source code via one or more compiler directives to a compiler instructing the compiler to map the compute element, and compiling, by the compiler, the source code including the one or more compiler directives.

In some aspects, the techniques described herein relate to a method, wherein analyzing the source code to identify the one or more code regions to be offloaded to a compute element includes analyzing the source code to identify the one or more code regions to be offloaded to an in-memory compute element by identifying one or more memory-intensive code regions, the one or more memory-intensive code regions including at least one of a redundant loop operation, a comparison operation, or a set operation.

In some aspects, the techniques described herein relate to a method, wherein compiling, by the compiler, the source code includes mapping instructions corresponding to the one or more code regions to a compute element, the compute element including an in-memory compute element, a near-memory compute element, or a far-memory compute element of a hardware compute node.

In some aspects, the techniques described herein relate to a method, further including executing, by the hardware compute node, a runtime to schedule and orchestrate the instructions and a dataflow to the in-memory compute element, the near-memory compute element, or the far-memory compute element.

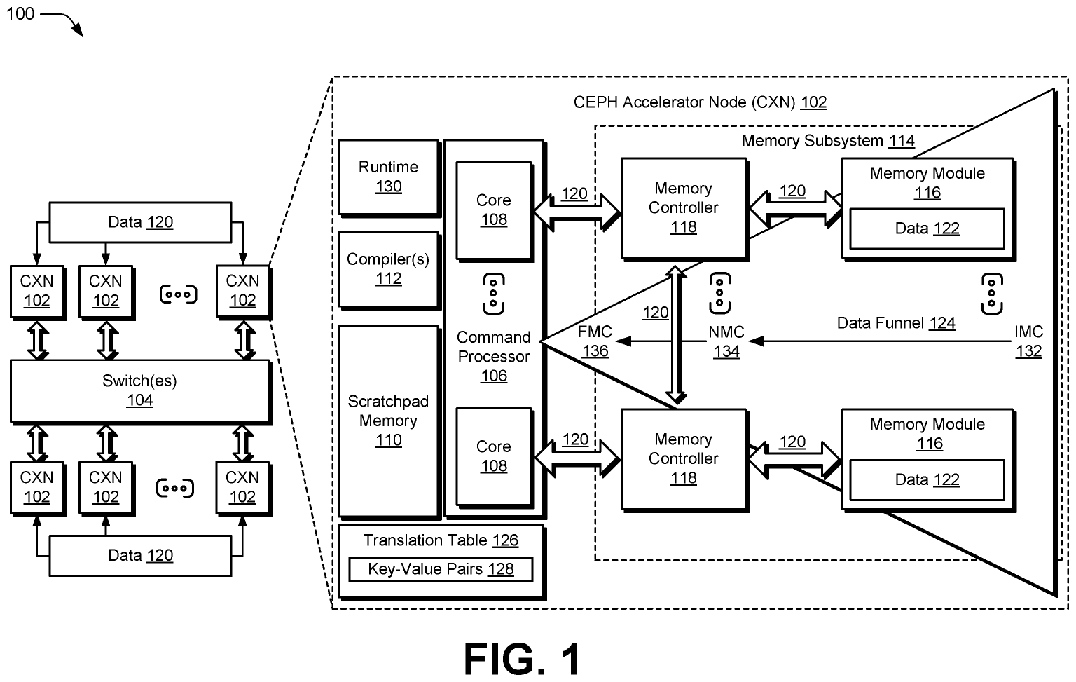

FIG. 1 is a block diagram of a non-limiting example of a compute everywhere using a processing hierarchy (CEPH) system 100 having one or more hardware nodes, specifically, one or more CEPH accelerator nodes 102 connected via one or more switches 104 which enable the CEPH accelerator nodes 102 to communicate with each other. The CEPH accelerator nodes 102 are hardware compute nodes that execute various computational tasks. In one example provided herein, the CEPH accelerator nodes 102 are implemented to reduce data movement in a graph processing service by enabling a compute everywhere model which includes computing far, near, and in-memory, as will be discussed in greater detail below. The switches 104 are high-speed, low-latency devices equipped with hardware components such as high-speed ports, switching fabrics, control and management units, and buffer memory, in addition to software and/or firmware configured to control the operation of the switches 104 and manage the network between the CEPH accelerator nodes 102.

In one or more implementations, the CEPH accelerator nodes 102 are servers or other individual computing systems operating as part of a larger cluster. Each CEPH accelerator node 102 includes a command processor 106. The command processor 106 is configured to orchestrate and schedule tasks across different compute elements within a CEPH accelerator node 102 depending on application instructions. More particularly, the command processor 106 orchestrates the dataflow pipeline (i.e., IMC element to NMC element to FMC element) and tasks to each compute elements provided by runtime instructions.

In one or more implementations, the command processor 106 is implemented as a central processing unit (CPU), a graphics processing unit (GPU), a field programmable gate array (FPGA), an accelerated processing unit (APU), a digital signal processor (DSP), or other specialized processing unit. The command processor 106 includes one or more cores 108. Each of the cores 108 is capable of executing its own tasks or threads independently of the other cores. The cores 108 enable the command processor 106 to handle multiple tasks concurrently. In some implementations, each of the cores 108 is configured to run an instruction stream and has a set of registers and a cache memory, allowing each core 108 to function as a separate processor within the command processor 106.

The CEPH accelerator nodes 102 also include a shared and addressable scratchpad memory 110. The scratchpad memory 110 is a high-speed, on-chip memory used for temporary data storage. The scratchpad memory 110 is managed by one or more compilers 112. The compiler(s) 112 are software compilers equipped with algorithms to determine which data or code segments would benefit most from being placed in the scratchpad memory 110. The compiler(s) 112 strategically place frequently accessed or critical data/code in the scratchpad memory 110 to ensure rapid and predictable access times, enhancing the overall efficiency of the CEPH system 100.

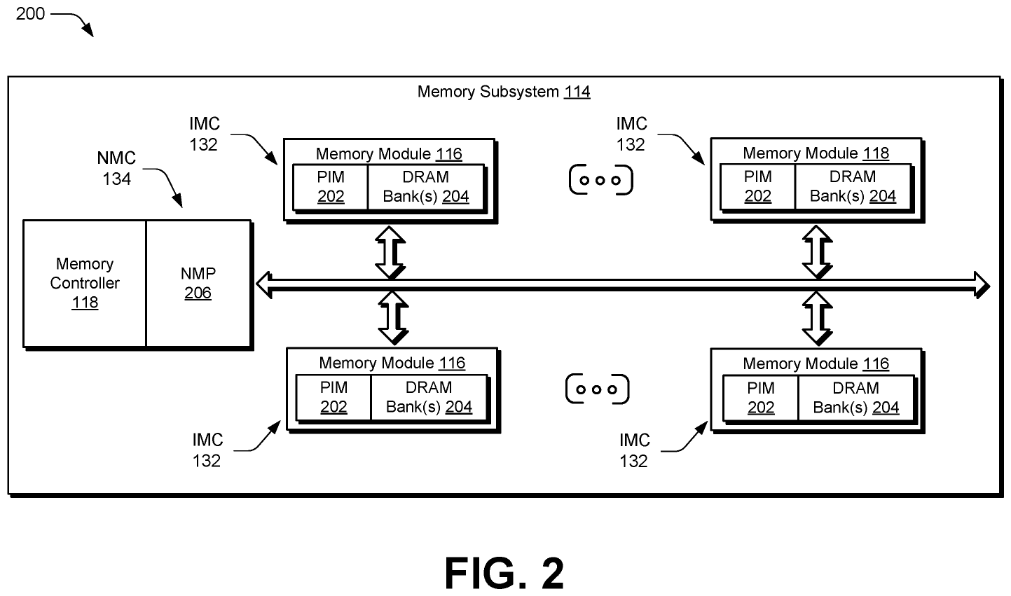

The CEPH accelerator nodes 102 also include a memory subsystem 114. The memory subsystem 114 includes one or more memory modules 116. The memory module(s) 116 are implemented as a printed circuit board, on which one or more memory chips (e.g., physical memory) are disposed (e.g., via physical and communicative coupling using one or more sockets). In other words, the memory chip(s) are mounted on a printed circuit board and this construction, along with the communicative couplings (e.g., control signals and buses) and one or more sockets integral with the printed circuit board, form the memory module 116. Examples of the memory modules 116 include, but are not limited to, a single in-line memory module (SIMM), a dual in-line memory module (DIMM), small outline DIMM (SODIMM), microDIMM, load-reduced DIMM, registered DIMM (R-DIMM), non-volatile DIMM (NVDIMM), high bandwidth memory (HBM), and the like. In one or more implementations, each memory module 116 is a single integrated circuit device that incorporates one or more memory banks and a PIM components on a single chip. An example of this is shown in FIG. 2. In some examples, the memory modules 116 are composed of multiple chips implemented as vertical (“3D”) stacks, placed side-by-side on an interposer or substrate, or assembled via a combination of vertical stacking and side-by-side placement. In at least one example, the memory modules 116 correspond to or include volatile memory, such as random-access memory (RAM), dynamic random-access memory (DRAM), synchronous dynamic random-access memory (SDRAM) (e.g., single data rate (SDR) SDRAM or double data rate (DDR) SDRAM), ferroelectric RAM (FeRAM), resistive RAM (RRAM), a spin-transfer torque magnetic RAM (STT-MRAM), and static random-access memory (SRAM).

In the illustrated example, each memory module 116 is connected to a memory controller 118 that controls the operation of the memory module 116. In alternative implementations, each memory controller 118 is connected to and controls the operation of multiple memory modules 116. The command processor 106, the memory modules 116, and the memory controllers 118 are shown as being connected via one or more interconnects 120, implemented, for example, as an interconnect fabric. The memory modules 116 are configured to store data 122, which is processed locally by the CEPH accelerator nodes 102 and distributed, as needed, among the CEPH accelerator nodes 102 via the switch(es) 104.

In a conventional graph analytics system, data is moved from a memory subsystem to compute registers through a cache hierarchy. The actual data required for processing is typically less than the data fetched. Moreover, the requester compute node may be local or remote. Despite this effort, most of the data is not reused, rendering caching effectively useless. This incurs a huge penalty for performance, resource utilization, and energy consumption. In many modern datacenters, the total cost of computation is governed, in large part, by data movement.

The CEPH system 100 effectively reduces data movement by providing a hierarchical data processing engine to match compute requirements at different levels within workloads. In the illustrated example, the hierarchical nature of the CEPH system 100 is depicted as a data funnel 124 which brings compute functionality closer to the data 122.

The illustrated CEPH system 100 depicts an overall architecture in which the data 122 (e.g., graph data), residing in the memory modules 116, is distributed among the CEPH accelerator nodes 102. In one or more implementations, the CEPH accelerator nodes 102 utilize a partitioned global address space (PGAS) addressing model. In the PGAS addressing model, a global address space is made accessible to compute elements, such as threads or processes. This unified view simplifies programming by allowing direct reads and writes to remote data. While the address space is unified, the address space is still partitioned, indicating that each compute element typically has a local portion of memory (e.g., a portion of the memory module 116) for which the compute element has fast access.

In the illustrated example, the global address space is provided by a translation table 126 that resides in each of the CEPH accelerator nodes 102. The translation table 126 provides functionality to translate remote memory addresses across the CEPH system 100. The translation table 126 contains key-value pairs 128 used to determine if the required memory access is to a local or remote memory. The key-value pairs 128 are representative of graph object identifiers, including vertex and edge identifiers.

A software runtime 130 (shown as “runtime”) and address translation using the translation table 126 are used to pull or push tasks from other CEPH accelerator nodes 102. The software runtime 130 has knowledge about the memory modules 116 and the layout, topology, and compute element availability across the CEPH accelerator nodes 102. This enables scheduling appropriate hardware events and orchestration of program and control dataflow in a distributed setup to service applications.

The command processor 106 orchestrates a hierarchical dataflow pipeline realized by the data funnel 124 formed from various compute elements depending on the distance (e.g., in terms of higher energy and performance penalty) of these compute elements from the data 122 stored in the memory modules 116. In the illustrated example, the hierarchy of the data funnel 124 is formed from in-memory compute or IMC element 132 to near-memory compute or NMC element 134 in the memory controller 118 to far-memory compute or FMC element 136 at the command processor 106.

Turning briefly to FIG. 2, a non-limiting example memory subsystem architecture 200 for the memory subsystem 114 of the CEPH system 100 will be described. In the illustrated example, the IMC elements 132 are PIM components 202 co-located with one or more DRAM banks 204 within the memory modules 116. For example, the memory modules 116 include a circuit board (e.g., a printed circuit board) on which hardware compute components (depicted as the PIM components 202) and hardware memory components (depicted as DRAM banks 204) are both mounted.

The PIM components 202 perform bitwise operations (e.g., AND, OR, and NOR) to effectively filter the data 122 at the memory modules 116. This is beneficial for low compute, high memory-intensive graph application kernels to save unnecessary data transfers. In one or more implementations, the DRAM banks 204 are selectively activated depending on the power requirements at a given time. Software-defined in-memory filtering reduces bulk data movement especially for graph mining workloads.

In one or more implementations, the NMC element 134 is a near memory processor or NMP 206, such as a processor core operating as part of the memory controller 118. The memory controllers 118 are configured to operate in different modes, such as one mode that enables regular memory load/store operations and another mode that enables simple compute operations. The NMC element 134 is lightweight and designed to execute simple computations such as gather or comparison operations (i.e., inter-bank operations) to reduce data movement off of the memory modules 116 towards the cores 108 of the command processor 106.

Returning to FIG. 1, in one or more implementations, the FMC elements 136 (e.g., the command processors 106 of each CEPH accelerator node 102) are connected via network-on-chip (NOC) interconnects with each having a local memory, and a shareable and addressable scratchpad memory (i.e., the scratchpad memory 110). The FMC elements 136 receive a pruned version of the data 122 from the memory controllers 118 and perform global operations, such as larger complex computations, on the data 122. For example, the FMC elements 136 create new data structures across the memory subsystem 114, perform remote data lookups (e.g., from other CEPH accelerator nodes 102), perform task push/pull operations, and/or perform data mergers for inter and intra-CEPH accelerator nodes 102, depending on the application.

The compiler(s) 112 and the runtime 130 provide directions to the command processor 106 for mapping application logic and dataflow to the hardware of the CEPH accelerator nodes 102, and specifically, to the IMC element 132, the NMC element 134, and the FMC element 136. The command processor 106 is responsible for orchestration and scheduling of tasks across the different compute elements in the CEPH accelerator nodes 102 depending on the application instructions executed in the runtime 130.

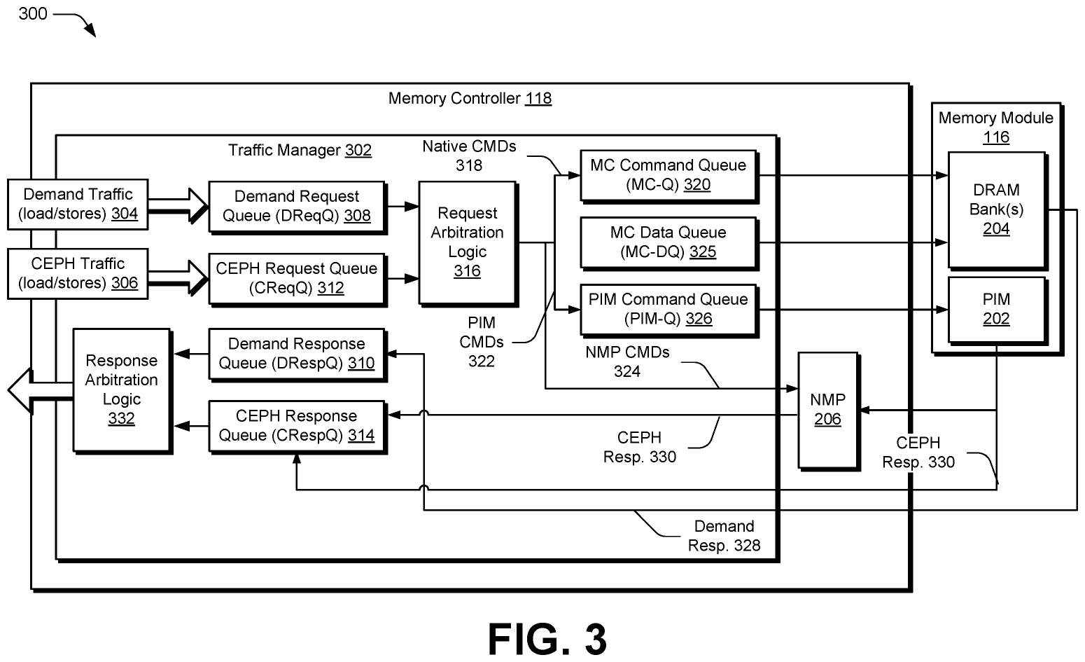

The computation model described above creates a data-filtering funnel (i.e., the data funnel 124), utilizing the compute elements across different hierarchies (i.e., the IMC element 132, the NMC element 134, and the FMC element 136). However, augmenting the compute elements, such as near (NMC-NMP) and in-memory (IMC-PIM) compute elements, adds contention due to an increase in traffic (compute and demand) at the memory controller 118 interface. However, to maximize the bandwidth, the memory controllers 118 should not operate exclusively in a single mode, and instead should allow for request reordering and prioritization based on traffic queueing heuristics. In an effort to mitigate exclusive single mode operations of the memory controllers 118, the memory controllers 118 include a traffic manager (shown in FIG. 3 as traffic manager 302). The traffic manager 302 enables the memory controllers 118 to seamlessly perform compute (near, in-memory) while also serving mission critical demand traffic. The traffic manager 302 will now be described with reference to FIG. 3.

FIG. 3 shows a non-limiting example memory controller architecture 300 of the memory controller 118 including the traffic manager 302. The traffic manager 302 segregates data traffic, including demand traffic 304 and CEPH traffic 306, into separate queues to manage traffic flow to and from the memory controller 118. The demand traffic 304 includes memory native load/store requests directed towards the data 122 stored in the DRAM bank(s) 204 in the memory module 116. The CEPH traffic 306 includes IMC load/store requests directed towards the PIM component 202 and NMC load/store requests directed towards the NMP 206. The traffic manager 302 includes request queues and response queues for each traffic type. In some implementations, these queues are implemented in one or more registers or memory blocks configured to store data and/or commands. In particular, a demand request queue 308 and a demand response queue 310 are shown for the demand traffic 304. Similarly, a compute everywhere processing hierarchy (CEPH) request queue 312 and a CEPH response queue 314 are shown for the CEPH traffic 306.

The traffic manager 302 also includes a request arbitration logic 316, which is either integrated as part of hardware circuitry of the memory controller 118 or included as one or more instruction sets executed by the hardware circuitry of the memory controller 118. The request arbitration logic 316 is configured to select requests from the demand request queue 308 and the CEPH request queue 312 and generate commands directed to appropriate command queues depending on the command type and destination. The request arbitration logic 316 selects requests from the demand request queue 308 and generates native commands 318 directed to a memory controller command queue 320. The request arbitration logic 316 also selects requests from the CEPH request queue 312 and generates PIM commands 322 and/or NMP commands 324 directed to a PIM command queue 326 and/or the NMP 206, respectively. The traffic manager 302 also include a memory controller data queue 325 that holds the data 122 temporarily before being sent to or retrieved from the memory module 116.

Similarly, for responses, the traffic manager 302 queues up demand responses 328 at the demand response queue 310. While CEPH responses 330 are either queued up towards the CEPH response queue 314 or towards the NMP 206. For the latter, the NMP 206 further processes the data 122 and writes the CEPH responses 330 to the CEPH response queue 314. A response arbitration logic 332 selects the demand responses 328 and the CEPH responses 330 from the demand response queue 310 and the CEPH response queue 314, respectfully, and sends the demand responses 328 and the CEPH responses 330 to the requesting entity, such as the command processor 106 or a specific core 108 thereof.

When a single type of traffic exists (i.e., only demand traffic 304 or only CEPH traffic 306), the traffic manager 302 maps data paths to the respective traffic. However, when both types of traffic exists (i.e., both demand traffic 304 and CEPH traffic 306), prioritization is used to maintain a desired quality of service (QoS) without violating memory consistency. Heuristics such as, but not limited to, queue occupancy, memory bandwidth, and average request completion latency are used in the request arbitration logic 316 for traffic prioritization.

The request arbitration logic 316 operates in the following modes. When the memory bandwidth utilization is low, equal opportunity is provided to both the demand traffic 304 and the CEPH traffic 306. After memory bandwidth utilization reaches a particular pre-set threshold, the priority slowly shifts towards demand requests and the request arbitration logic 316 starts operating in burst mode. While in burst mode, the request arbitration logic 316 attempts to schedule more commands from the demand requests queue 308 before scheduling commands from the CEPH request queue 312. During high bandwidth utilization, priority is given to demand requests, however, the traffic manager 302 also monitors occupancy within the CEPH request queue 312. If the CEPH request queue 312 starts backing up (i.e., approaches a pre-set upper threshold), the request arbitration logic 316 switches to scheduling CEPH requests until the CEPH request queue 312 reaches a pre-set lower threshold. In other embodiments, the request arbitration logic 316 defines alternative policies such as prioritizing CEPH requests over demand requests. The request arbitration logic 316 balances a base level of QoS to the queues to avoid clogging the memory subsystem 114.

The discussion above focuses on various hardware architecture aspects of the concepts and technologies disclosed herein. The concepts and technologies disclosed herein also provide a software stack, implemented by the compiler(s) 112 and the runtime 130, to map existing graph application implementations from traditional systems to the CEPH system 100. Aspects of this software stack will now be described.

The following discussion utilizes an example graph pattern matching workload as a reference implementation mapped to the CEPH system 100. It should be understood, however, that the concepts and technologies disclosed herein are not limited to any particular workload. Moreover, the following discussion is described without conveying proprietary data of the example graph pattern matching workload. Those skilled in the art, however, will readily appreciate the applicability of the following description to workloads in real-world implementations.

The amount of input data of graph application workloads is oftentimes orders of magnitude larger than the resulting output data. For example, in the example graph pattern matching workload mentioned above, the output data is 0.00002% of the input data. In traditional systems, this large corpus of input data is read and reread multiple times, wasting numerous read cycles when a small portion of the input data is used to perform computations. When a computation is performed, the entire graph object is read even if only a small portion of the data 122 contained in the graph object is actually used in a computation. Moreover, any computations are often trivial, and in the example graph pattern matching workload, are used for comparison and filter operations that are combinations of simple, similar, and redundant operations. Due to the distributed nature of graph applications and the data 122 being spread across the CEPH accelerator nodes 102, a significant fraction of the reads triggers remote communication with other CEPH accelerator nodes 102.

The concepts and technologies disclosed herein are applicable to a large class of graph data analytics applications, such as, but not limited to, graph neural networks (GNN), graph mining, k-mer counting genomics, ISBs (e.g., triangle counting), Jaccard index, as well as mission critical security metadata analyses, and the like. These applications typically exhibit the same characteristics for near-memory acceleration. These graph queries exhibit similar attributes of sparseness and being memory extensive. In this case, the compute is highly undersubscribed due to the irregular accesses and majority of time being spent waiting for the data 122. Graph queries are typically read-only. However, a programmer should make sure that no data is updated while a compute is in-flight. In the concepts and technologies described herein, in addition to the hardware components of the CEPH system 100 described above with reference to FIGS. 1-3, additional software components are implemented to enable the computation model. The benefits of a software-based algorithmic refactoring, as well as an example methodology to map optimized code to the hardware of the CEPH system 100 will now be described.

Without affecting the correctness of the algorithm, the same software code is rewritten to reduce redundancy and effectively use the underlying hardware of the CEPH system 100. For instance, the reference implementation of graph pattern mining mentioned above is re-written in a bottom-up approach instead of top-down in original form. By doing so, the CEPH system 100 performs filter condition checks at the same time, thereby reducing redundant passes over the data 122. The rest of the computation follows. This software-only refactoring optimization reduces off-chip read traffic by ˜30% and provides a 20-30% performance improvement over the reference implementation, which also scales with increasing data-sizes. Software refactoring is capable of being applied to a large variety of graph workloads.

Through algorithmic refactoring and characterization, potential candidates are identified to match computing capabilities. The identified code blocks or instructions are offloaded to the corresponding compute element (e.g., FMC element 136, NMC element 134, or IMC element 132) by specifying regions in the source code via compiler directives. For instance, the memory intensive portions of the workflows are identified by observing redundant loops, comparisons (=, <, >), set operations, and the like. The data is reduced at the source using simple calculations and minimal overheads. During compilation, the compiler directives provide hints to the compiler(s) 112 for mapping instructions to hardware modules for the IMC element 132, the NMC element 134, and FMC element 136 processing. The runtime 130 schedules and orchestrates instructions and dataflows to specific compute elements.

As mentioned above, a translation table 126 is local to each of the CEPH accelerator nodes 102. The translation table 126 contains key-value pairs 128 (i.e., vertex/edge_id:address) used to determine if access is to local or remote memory. The command processor 106 orchestrates dataflow through the data funnel 124 (i.e., from the IMC element 132 to the NMC element 134 to the FMC element 136) and tasks to be sent to each of these compute elements per the runtime 130. The command processor 106 also translates PGAS addresses into physical memory addresses using the translation table 126. The command processor 106 schedules the instructions per the data flow pipeline.

For the IMC elements 132, PIM-specific instructions, which perform major data pruning (i.e., filter ops) are directed to corresponding memory controllers 118. The traffic manager 302 in the memory controller 118 schedules and actives the appropriate IMC elements 132 (e.g., PIM-DRAM banks) with specific instructions, including source-address, operations, operands, and destination address. The PIM component 202 checks for combined filter conditions and uses a local scratchpad to hold temporary register for each filter condition storing as a Boolean. On completion of the filter operations, the PIM component 202 reads the temporary register values and performs a set of conditions per edge object within the data 122. The final output (i.e., values of the conditions) is stored in pre-determined register files or address ranges in the DRAM bank 204, and the PIM component 202 then sets a completion-flag.

For the NMC elements 134, the NMP 206 in the memory controller 118 aggregates and reduces the result from multiple PIM-enabled DRAM banks and performs these simple operations to further prune the data 122 for processing at the FMC element 136. A thread in the NMP 206 keeps tracks of all PIM-enabled in-flight traffic by polling the pre-determined register files for checking the completion-flag value per edge. If the completion flag is set (i.e., value=1) for a PIM-enabled instruction, the NMP 206 reads the register file condition variables and performs further processing. The NMP 206 maintains a small local buffer (queue) for storing the results for edges where the condition(s) is/are met. This further translates into transferring off-chip only relevant properties (key-value pairs) from the already pruned graph objects, thereby reducing the actual access amplification (8 bytes out of 64 bytes).

For the FMC elements 136, the cores 108 receive the NMP 206 queue of relevant edge-properties as responses (i.e., CEPH responses 330) via the traffic manager 302 in the memory controller 118 for further processing. In some implementations, processing in the FMC elements 136 uses combinations of looking up relevant objects across different graph containers depending on the entries in the NMP queue or creating new data structures for global graphs stored across the CEPH accelerator nodes 102. These operations require access to other memory subsystems 114 in the same or remote CEPH accelerator nodes 102 via the switches 104. The locality is determined by using the translation table 126 using the edge/vertex-ID of the key-value pairs 128 as the key. If local, the core 108 sends demand traffic (load/store) 304 to the corresponding memory controller 118 using its physical address, followed by the processing logic once the data 122 is ready. However, if remote, the core 108 interacts with the command processor 106 for scheduling with the runtime 130 to push the instructions to the designated remote CEPH accelerator node 102, where a vertex/edge directory of the switch(es) 104 determines the locality of the job and updates the runtime 130 accordingly. Once the set of instructions designated for a particular application in a CEPH accelerator node 102 commences, the command processor 106 marks the completion of events.

The runtime 130 has the knowledge of application dependencies and task assignments across the CEPH accelerator nodes 102 as well as the data movement needed for completion of the application logic to collect results. The runtime 130 coordinates with the command processor 106 by monitoring the completion of events per application in the CEPH accelerator nodes 102. The intermediate data structures, memory ranges (e.g., register files, queues, and buffers) are released, and garbage is collected.

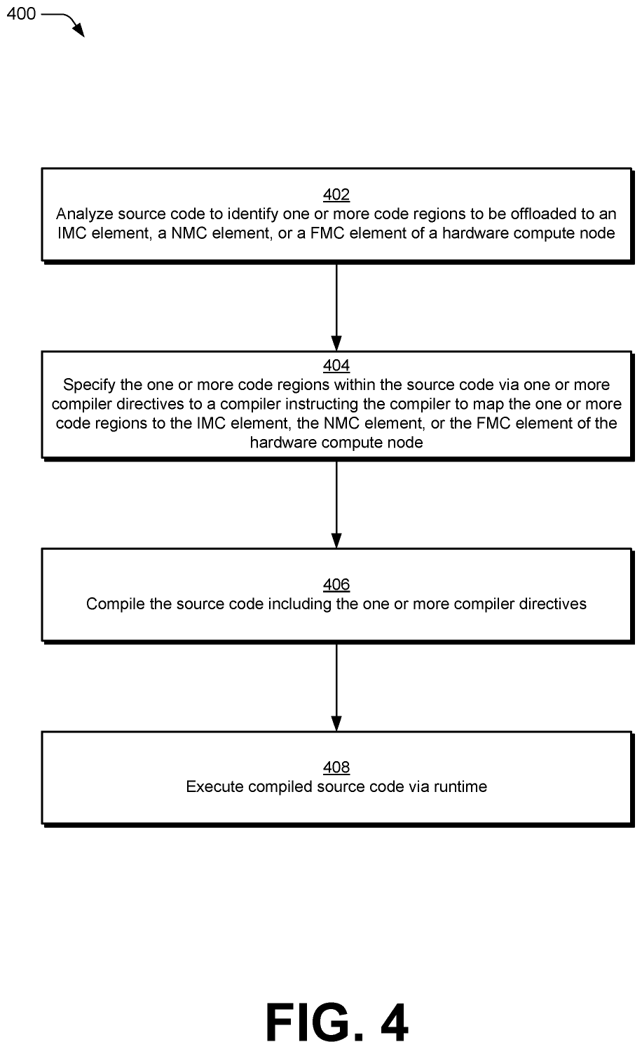

FIG. 4 is a flowchart of an example method 400 for implementing a CEPH optimized software directed data flow in hardware. The method 400 begins when an analysis of source code is performed to identify one or more code regions to be offloaded to the IMC element 132, the NMC element 134, or the FMC element 136 of the CEPH accelerator node 102 (block 402). The one or more code regions within the source code are then specified to the compiler 112 via one or more compiler directives that map the one or more code regions to the IMC element 132, the NMC element 134, or the FMC element 136 of the CEPH accelerator node 102 (block 404). In one or more implementations, the compiler directives include “Pragma” compiler directives which are special instructions to the compiler 112 to request or specify behavior that is outside the standard features of a programming language. In other words, the “Pragma” compiler directives provide additional guidance to the compiler 112 to map the one or more code regions to the IMC element 132, the NMC element 134, or the FMC element 136 of the CEPH accelerator node 102.

The compiler 112 then compiles the source code which includes the one or more compiler directives (block 406). The compiled source code is then executed via the runtime 130, which schedules and orchestrates instructions and data flow to specific compute elements, such as the IMC element 132, the NMC element 134, and/or the FMC element 136.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein including, where appropriate, the CEPH accelerator node(s) 102, the switch(es) 104, the command processor(s) 106, the core(s) 108, the scratchpad memory 110, the compiler(s) 112, the runtime(s) 130, the memory controller(s) 118, the memory subsystem(s) 114, the memory module(s) 116, the translation table(s) 126, the IMC elements 132, the NMC elements 134, the FMC elements 136, the interconnect(s) 120, the PIM component(s) 202, the DRAM bank(s) 204, the NMP 206, the traffic manager 302, the demand request queue(s) 308, the demand response queue(s) 310, the CEPH request queue(s) 312, the CEPH response queue(s) 314, the request arbitration logic 316, the memory controller command queue(s) 320, the memory controller data queue(s) 325, the PIM command queue 326, and the response arbitration logic 332 are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A system comprising:
one or more switches; and
a plurality of hardware compute nodes connected via the one or more switches, each hardware compute node of the plurality of hardware compute nodes comprising:
an in-memory compute element configured to perform in-memory processing operations on data;
a near-memory compute element configured to perform near-memory processing operations on the data; and
a far-memory compute element configured to perform far-memory processing operations on the data.

2. The system of claim 1, further comprising a circuit board having memory mounted to the circuit board, the circuit board comprising:
the in-memory compute element; and
one or more dynamic random-access memory banks.

3. The system of claim 2, wherein the in-memory compute element comprises a processing-in-memory component.

4. The system of claim 3, further comprising a memory controller, the memory controller comprising the near-memory compute element.

5. The system of claim 4, wherein the near-memory compute element comprises a near-memory processor, and the memory controller further comprises a traffic manager configured to direct traffic towards the near-memory processor, the processing-in-memory component, or the one or more dynamic random-access memory banks.

6. The system of claim 5, wherein the traffic manager comprises:
a data queue configured to queue the data;
a demand request queue configured to queue demand requests from the traffic;
a compute everywhere processing hierarchy (CEPH) request queue configured to queue CEPH requests from the traffic; and
a request arbitration logic configured to:
direct native commands associated with the demand requests towards the memory;
direct processing-in-memory commands associated the CEPH requests towards the processing-in-memory component to perform the in-memory processing operations on the data; and
direct near-memory processing commands associated with the CEPH requests towards the near-memory processor to perform the near-memory processing operations on the data.

7. The system of claim 6, wherein the traffic manager further comprises:
a demand response queue configured to queue demand responses;
a CEPH response queue configured to queue CEPH responses; and
a response arbitration logic configured to direct the demand responses and the CEPH responses towards the far-memory compute element to perform the far-memory processing operations on the data.

8. The system of claim 7, wherein the far-memory compute element comprises a command processor comprising one or more processing cores.

9. The system of claim 8, wherein the command processor comprises a local command processor of a local hardware compute node of the plurality of hardware compute nodes or a remote command processor of a remote hardware compute node of the plurality of hardware compute nodes.

10. The system of claim 1, wherein the data comprises graph data.

11. A hardware compute node comprising:
an in-memory compute element configured to perform in-memory processing operations on data;
a near-memory compute element configured to perform near-memory processing operations on the data; and
a far-memory compute element configured to perform far-memory processing operations on the data.

12. The hardware compute node of claim 11, further comprising a memory system, the memory system comprising:
the in-memory compute element; and
one or more dynamic random-access memory banks.

13. The hardware compute node of claim 12, wherein the in-memory compute element comprises a processing-in-memory component.

14. The hardware compute node of claim 13, wherein the near-memory compute element comprises a near-memory processor; and the hardware compute node further comprises:
a traffic manager of a memory controller, the traffic manager comprising:
a data queue configured to queue the data;
a demand request queue configured to queue demand requests; and
a compute everywhere processing hierarchy (CEPH) request queue configured to queue CEPH requests; and
a request arbitration logic of the memory controller, the request arbitration logic configured to:
direct native commands associated with the demand requests towards the memory system;
direct processing-in-memory commands associated with the CEPH requests towards the processing-in-memory component to perform the in-memory processing operations on the data; and
direct near-memory processing commands associated with the CEPH requests towards the near-memory processor to perform the near-memory processing operations on the data.

15. The hardware compute node of claim 14, wherein the traffic manager further comprises:
a demand response queue configured to queue demand responses;
a CEPH response queue configured to queue CEPH responses; and
a response arbitration logic configured to direct the demand responses and the CEPH responses towards the far-memory compute element to perform the far-memory processing operations on the data.

16. The hardware compute node of claim 15, wherein the far-memory compute element comprises a command processor comprising one or more cores.

17. A method comprising:
analyzing source code to identify one or more code regions to be offloaded to a compute element;
specifying the one or more code regions within the source code via one or more compiler directives to a compiler instructing the compiler to map the compute element; and
compiling, by the compiler, the source code comprising the one or more compiler directives.

18. The method of claim 17, wherein analyzing the source code to identify the one or more code regions to be offloaded to the compute element comprises analyzing the source code to identify the one or more code regions to be offloaded to an in-memory compute element by identifying one or more memory-intensive code regions, the one or more memory-intensive code regions comprising at least one of a redundant loop operation, a comparison operation, or a set operation.

19. The method of claim 17, wherein compiling, by the compiler, the source code comprises mapping instructions corresponding to the one or more code regions to the compute element comprising an in-memory compute element, a near-memory compute element, or a far-memory compute element of a hardware compute node.

20. The method of claim 19, further comprising:
executing, by the hardware compute node, a runtime to schedule and orchestrate the instructions corresponding to the one or more code regions and a dataflow to the in-memory compute element, the near-memory compute element, or the far-memory compute element.
